(19) United States
(12) Patent Application Publication
(10) Pub. No.: US 2017/0247549 A1
(43) Pub. Date: Aug. 31, 2017

(54) ECOLOGICAL EMULSIFIABLE WATER REPELLENT AGENT WITH HIGH SOLID CONTENT COMPATIBLE WITH THERMOSET RESINS

(71) Applicant: Sion Nanotec Ltda, Sao Paulo, SP (BR)

(72) Inventors: Clovis Padovani, Araras, SP (BR); Anderson Nicolai, Campinas, SP (BR); Hugo Wizenberg, Sao Paulo, SP (BR); Rotta Albio Calvette, Sao Paulo, SP (BR)

(21) Appl. No.: 15/120,414

(22) PCT Filed: Feb. 21, 2014
(86) PCT No.: PCT/IB14/59165

§ 371 Date: Aug. 19, 2016

(51) Int. Cl. C09D 5/02; C09D 161/24; B27N 3/00; C09D 7/12

(52) U.S. Cl. CPC C09D 5/027; C09D 7/1233; C09D 5/022; C09D 161/24; B27N 3/002

(57) ABSTRACT

The current invention presents an ecological emulsifiable system (nanometric colloidal dispersion), with solid content higher than 90%, ecological, compatible with urea resins using linear and/or branched carbon saturated chains known for their water repellence, compatible with the bonding resins; adherence of plywood and agglomerate wood boards, formaldehyde known as urea resins, specifically urea acting as single binding, with water repellence property without changing the particle adherence provided to plywood or agglomerate wood boards, preserving the dimensional stability of plywood and/or. agglomerate wood board and not affecting the preserving metallic additives/salts by reducing the formaldehyde emission.

The current invention presents an ecological emulsifiable system (nanometric colloidal dispersion), with solid content higher than 90%, compatible with urea resins using linear and/or branched carbon saturated chains known for their water repellence, compatible with the bonding resins; adherence of plywood and agglomerate wood boards, known as urea resins, specifically urea formaldehyde acting as single binder, with water repellence property without changing the particle adherence provided to plywood or agglomerate wood boards, preserving the dimensional stability of plywood and/or agglomerate wood board and not affecting the preserving metallic additives/salts by reducing the formaldehyde emission.

The system is based on an emulsifiable hydroxylated linear organic structure, with a c18-c40 range carbon chain compatible and solubilized in urea formaldehyde resin.

### TECHNIQUE STATUS

### International Patents

### WO/2010/054467 05/2010 SINNIGE ET AL;

### WO/2009/062312 05/2009 RACOTA.

### American Patents

| | |
|---|---|
| US 2009/0326166 | December 2009 NO ET AL 525/509; |
| U.S. Pat. No. 77,364,559 | June 2012 RIVERS ET AL 264/109; |
| U.S. Pat. No. 7,264,886 | July 2007 CUI ET AL 428/536; |
| US 2006/0234077 | October 2006 BREYER ET AL 428/528; |
| US 2005/0277733 | December 2005 WESCOTT ET AL 524/589; |
| U.S. Pat. No. 6,274,199 | August 2001 PRESTON ET AL 427/298; |
| U.S. Pat. No. 6,132,885 | October 2000 PEEK ET AL 428/528; |
| U.S. Pat. No. 4,323,602 | April 1982 PARKER 427/298; |
| U.S. Pat. No. 3,832,463 | August 1974 NICHOLSON 424/131. |

### Patent Goals

The bonding process of wood boards and their particles, under the plywood or agglomerate wood form, is widespread and known, as well as the treatments and preservatives used on the wood during its production process.

Lately, by the environmental aspects, the urea resin has been explored regarding the formaldehyde emission to the atmosphere and a series of environmental studies have been performed.

The international patent WO/2010/054467 shows the reduction of formaldehyde emission or the presence of free formaldehyde, for emulsifying the paraffin with urea based agents and creates a series of phases in resin process production in order to achieve the effect of reduction at minimal levels, but its base is an anionic emulsion which needs several modifications and changes, that is, there is not a single phase in the formaldehyde resin in the direct application on the plywood or agglomerate wood boards, compelling each production of wood boards to be adjusted to the ideal amount of emulsion.

The U.S. Pat. No. 7,264,886 and U.S. Pat. No. 4,323,602 only mention the water repellence properties and compatibility with metallic ester based preservatives without sticking to the compatibility or effects on the bonding resins.

Thus, the goal of present patent is to conciliate in a single phase the need of an initial bonding activity and a subsequent treatment on the board in order to increase the water repellence, through the concept of ecological high solid content in the urea resin.

Conceptually the urea resin, specifically urea formaldehyde, is produced under conditions in which the introduction of alcohol of low molecular weight (C2 to C5) enables the control and the orientation of the order of the reactions allowing the stability to the urea formaldehyde bond.

The incorporation happens in the formaldehyde solution medium with the use of polyols such as glycols, glycerols and/or polyols, allows how the final reaction system of the production of the thermoset resin of urea formaldehyde type allows the presence of an emulsifiable system with high solid content in the radical which bears the polyols.

Conceptually there is the possibility of acting on the methylol group, specifically on the hydroxyl and through hydrogen bridges include a saturated chain that can be hydrocarbon saturated, olefin unsaturated or a methylic structured derived from carbon chemistry.

The system must specifically be totally emulsifiable or the solid content must be higher than 90% or simply self-emulsify the resin, by using solely the reaction means of urea formaldehyde production, not sticking to the surfactant, because the ideal hlb of the water repellence system is 10-12.

The system hydrophobicity and hydrophilicity must be controlled, for the affinity to the oil of the system is controlled by the water repellence on the wood and the water affinity will be provided by the characteristic adherence or bonding of the urea formaldehyde system soluble in water.

Concerning the hydrophilicity, it is achieved by the water repellence in the wood surface treatment, we know that when the correct thickness or application angle on this surface is achieved, the dimensional stability of the plywood board is achieved as well, so we also search for the repellence, adherence and dimensional stability on the plywood or agglomerate wood.

Basically the system is soluble in water, facilitating the incorporation directly in resin production, in opposition to what was shown in the international patent WO/2010/054467, which operates 2 phases without specifically working the concept of high content of solids or 100% of non volatile.

The objective of the present invention is to introduce a hydrocarbon wax at 100% of solids, emulsifiable, ecological, compatible with the formaldehyde resin, urea formaldehyde based.

The hydrocarbon systems presented here consider renewable, natural systems and environmentally approved, avoiding the increase of characteristics harmful or toxic to the environment, minimizing the effect of the formaldehyde emission by the bonding urea formaldehyde based resin.

### Advantages of the Invention

The present invention includes an original emulsifiable nanometric colloidal dispersion system, with 100% of solids hydrocarbon wax based totally soluble and compatible with the formaldehyde resin without affecting the boards bonding, helping the complete reaction with the resin leading to the emission control of free formaldehyde.

### Characteristics or the Invention

Assembly of a hydrocarbon wax, correcting its chromatography, by determining the percentage of C30 to C44:

### C30—0/2%;

### C32—1/5%;

### C34—5/10%;

### C36—10/20%;

### C38—30/40%;

### C40—20/30%;

### C42—10/20%;

### C44—5/10%.

Correction of the hydrocarbon wax with vegetable fatty acids on the range of C14 to C22, with inclusions chromatographically controlled:

### C14 −1/5%;

### C16:0 20/30%;

### C16:1 1/5%;

### C18:0 10/20%;

### C18:1 50/60%;

### C18:2 5/10%;

### C20:0 5/10%;

### C20:1 0/1%;

### C22:0 1/5%.

Reaction of the saturated hydrocarbon wax, whose composition is generated by the arrangement of the carbon chains with non-ionic surfactants based on secondary amines, tertiary amines, ammonia and its salts, urea and its salts.

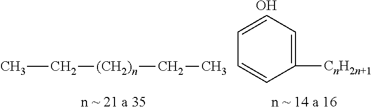

Formation of 100% emulsifiable nanometric colloidal dispersion with the action of an alkalinizing agent including a metallic oxide or hydroxide with homogenizing action able to adjust by particle size, determined between 1 micron and 200 nanometers;

MₑOH
Reaction of the emulsifiable hydrocarbon chain, 100% of solids, with the urea formaldehyde resin, preferably the urea formaldehyde resin under the temperature range of 60-150° C., preferably 80-120° C., under constant shaking and miscibility control.

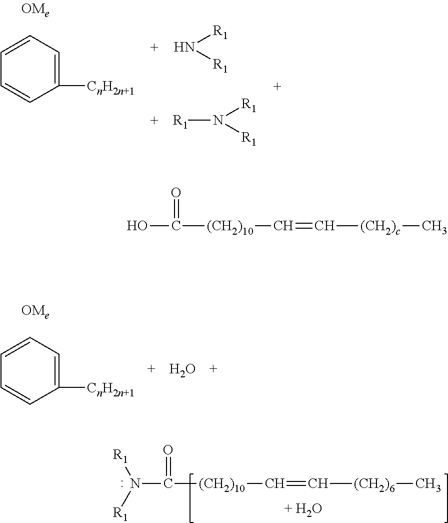

### BRIEF DESCRIPTION OF DRAWINGS

FIG. 1 shows the graphic representation of the carbon distribution; and.

FIG. 2 shows the graphic representation of the differential scanning calorimetry—DSC.

### DESCRIPTION OF INVENTION IN DETAILS

The present invention acts on the urea formaldehyde resin, agglutination, bonding or adhesive agents between the plywood or agglomerate wood boards.

The emulsion is based on linear and/or branched saturated hydrocarbon, vegetal origin derivatives including fatty acids from soy, corn, palm leaf, canola, cotton, sunflower, peanut, castor bean, rice and carnauba and/or of animal origin, comprised by triglycerides, nominally known as sebum fatty acids and/or mineral origin, originated from carbon chemistry, whose basic structure is methylene, with defined chemical composition, known as n-paraffin.

Besides these hydrocarbon chains, those of petrochemical origin have the same activity, obtained from the petroleum refinement, by getting naphtha, which are the sources of raw materials known as primary olefins, in the form of homopolymers, being the most known the ethylene and propylene homopolymers.

Those of vegetable origin known as vegetable polymers, such as sugar cane wax and the insect waxes are included here, known as beeswax.

In addition to Montana wax of mineral origin, the polyamide waxes are included as well.

Waxes then become the structure or main chain (according to the drawing) and thus defined by the composition of its linear saturated hydrocarbon chain, with a chain between C18 and C42.

The emulsion consists of a system of self-emulsifiable nanometric colloidal dispersion, which means that the system proposed to incorporate the resin is water free, but compatible with its polarity and cured together with urea formaldehyde resin, because of the proper ph which serves as a binding material without damaging the “tack” properties—resin adherence, incorporating the water repellence.

The urea formaldehyde resins are known and used a lot as wood binding, mainly because of cost factor and adherence factor in the assembly of plywood and agglomerate wood boards, hereinafter called MDF and MDP.

The present invention works specifically with the urea resin based on urea formaldehyde according to the examples and tests;

The emulsifiable nanometric colloidal dispersion system enters in reaction and compatibility with the urea formaldehyde resin in temperature range between 60 to 130° C., more precisely between 90 and 110° C., being fundamental that the ph of the emulsifiable nanometric colloidal dispersion system is exactly equal to the ph of resin, as well as the hydrophilic lipophilic balance (HLB) of the emulsifiable nanometric colloidal dispersion system is corrected exactly according to the HLB of the resin.

### Wax Chromatography

### Wax DSC (FIG. 2)

Emulsifiable wax testing with resin, pk and ph assembly.
Ideal PH from 7.8 to 8.2
HLB calculated for the emulsifiable wax;
HLB calculated from 10 to 12;
Formula with urea formaldehyde resin at 40/50 and 70% of NV and the different results;

### Demonstration of the Emulsifiable Single System—Urea Formaldehyde Resin;

### System FTIR—Fourier Transformed

### GPC (Gas Chromatography) of the Water-Repellent Additive

### Characteristics of the Water Repellent Additive

### Gas Chromatography:

| QUANTIFICATION | % |
|---|---|
| N-Paraffin | 76.00 |
| C25-C29 | 46.00 |
| C30-C34 | 28.00 |
| C35-C39 | 7.00 |
| BIGGER THAN C40 | 3.00 |

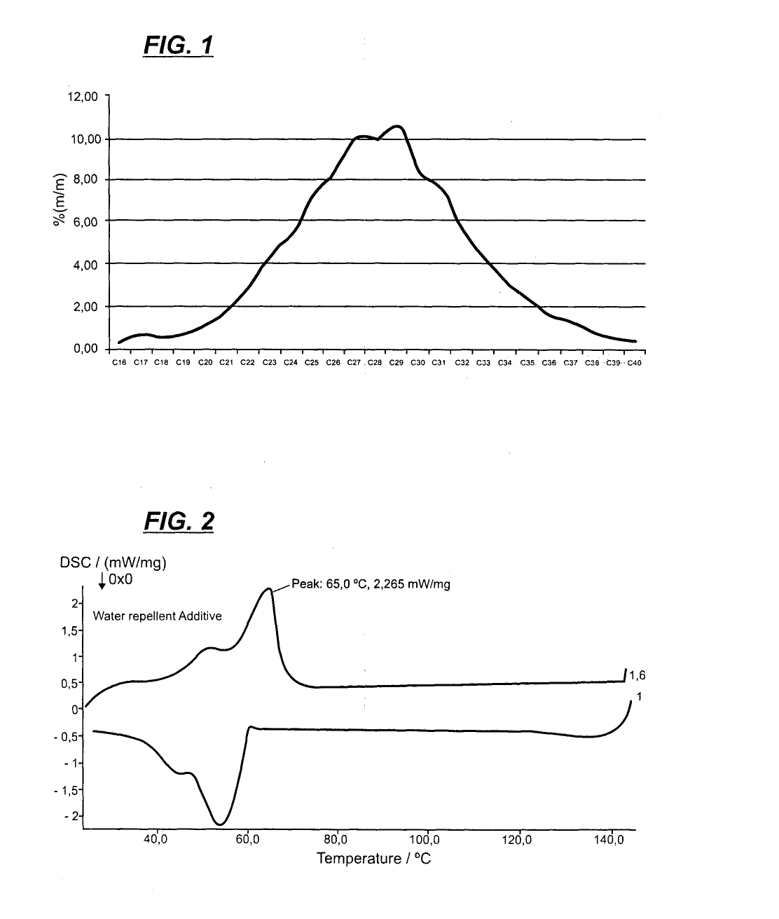

### Carbon Distribution (FIG. 1)

The water repellent additive has a high content of n-paraffin of 60-80%, being its biggest concentration around an average of 30 to 50%, in the carbon range of 025-29. The amount of isoparaffin is in the range of 10-20%, being its concentration mostly in the range of carbon C30 to C49.

### Differential Scanning Calorimetry—DSC (FIG. 2)

The analysis of differential scanning calorimetry in waxes shows the quality assurance of the present invention regarding the mixture standards performed and the product identity, proving the efficiency of the product in the characteristic of the invention.

The DSC of the water repellent additive shows a crystallization point around 60° C. with a melting point around 65° C.

Tests Performed with Water Repellent Additive on Boards

The data shown on tables 01 and 02 were obtained at specialized laboratory of a manufacturer of MDF and MDP boards.

The test is about the application of additive on MDF and MDP boards, in a ratio pre-set by the company, thus analyzing the swelling/absorption of water, on 15 mm and 18 mm boards, with the maximum pattern of 12%.

The initial additive ratio (dosage) for the 12 mm board was 0.35 and later decreasing to 0.32%; thus in both cases 0.35 and 0.32, the swelling were kept way below 12%, creating in the second dosage a reduction of consumption around 9.5%.

For the 18 mm boards, the dosage was 0.28; resulting in swelling smaller than 12%.

TABLE 01

| | Water | | | | | | | | | Maximum |
|---|---|---|---|---|---|---|---|---|---|---|
| Product | repellent ratio | Track 1 | Track 2 | Track 3 | Track 4 | Track 5 | Track 6 | Track 7 | Average | Pattern |
| 15 STDM | 0.35 | 9.06 | 9.16 | 8.15 | 8.15 | 8.36 | 8.63 | 8.97 | 8.64 | 12 |
| 15 STDM | 0.35 | 11.68 | 9.27 | 8.65 | 9 | 9.11 | 9.32 | 10.24 | 9.61 | 12 |
| 15 STDM | 0.35 | 8.91 | 8.33 | 8.48 | 9.44 | 9.42 | 9.2 | 9.13 | 8.99 | 12 |
| 15 STDM | 0.35 | 9.01 | 9.23 | 8.98 | 9.27 | 8.75 | 9.31 | 8.57 | 9.02 | 12 |
| 15 STDM | 0.35 | 9.58 | 10.66 | 10.05 | 10.45 | 10.01 | 10.28 | 10.24 | 10.18 | 12 |
| 15 STDM | 0.32 | 9.28 | 9.86 | 9.89 | 9.58 | 10.34 | 10.07 | 9.49 | 9.79 | 12 |
| 15 STDM | 0.32 | 10.38 | 12.23 | 12.28 | 11.23 | 10.45 | 12.28 | 10.3 | 11.31 | 12 |
| 15 STDM | 0.32 | 10.33 | 10.32 | 10.05 | 11.97 | 8.91 | 11.84 | 10.2 | 10.52 | 12 |
| 15 STDM | 0.32 | 9.88 | 11.11 | 9.88 | 9.83 | 9.74 | 10.73 | 10.98 | 10.31 | 12 |
| 15 STDM | 0.32 | 10.95 | 12.43 | 9.93 | 11.56 | 10.6 | 12.79 | 10.27 | 11.22 | 12 |
| 15 STDM | 0.32 | 9.52 | 7.31 | 10.73 | 10 | 8.29 | 11.29 | 9.72 | 9.57 | 12 |
| 15 STDM | 0.32 | 9.58 | 9.29 | 7.5 | 7.62 | 7.28 | 7.88 | 8.35 | 8.21 | 12 |
| 15 STDM | 0.32 | 7.59 | 8.32 | 9.1 | 7.8 | 8.04 | 8.18 | 9.05 | 8.3 | 12 |

TABLE 02

| | Water | | | | | | | | | Maximum |
|---|---|---|---|---|---|---|---|---|---|---|
| Product | repellent ratio | Track 1 | Track 2 | Track 3 | Track 4 | Track 5 | Track 6 | Track 7 | Average | Pattern |
| 18 STDM | 0.28 | 6.2 | 6.6 | 8.96 | 6.76 | 6.32 | 6.58 | 7.05 | 6.64 | 12 |
| 18 STDM | 0.28 | 6.05 | 7.21 | 5.74 | 6.48 | 6.35 | 6.58 | 6.21 | 6.37 | 12 |
| 18 STDM | 0.28 | 10.22 | 6.3 | 6.34 | 6.94 | 7.04 | 6.46 | 6.35 | 7.09 | 12 |
| 18 STDM | 0.28 | 6.83 | 6.63 | 7.02 | 7.23 | 6.49 | 7.46 | 7.24 | 6.99 | 12 |
| 18 STDM | 0.28 | 7.45 | 6.83 | 7.28 | 7.87 | 6.31 | 7.09 | 6.7 | 7.08 | 12 |
| 18 STDM | 0.28 | 9.04 | 14.05 | 15.36 | 10.75 | 14.29 | 8.94 | 10.19 | 11.8 | 12 |
| 18 STDM | 0.28 | 6.55 | 7.26 | 6.7 | 7.06 | 7.06 | 6.63 | 7.06 | 6.9 | 12 |
| 18 STDM | 0.28 | 9.09 | 9.21 | 8.97 | 8.34 | 8.07 | 8.71 | 9 | 8.77 | 12 |
| 18 STDM | 0.28 | 9.52 | 9.44 | 9.35 | 9.69 | 9.48 | 10.06 | 8.94 | 9.5 | 12 |

1. An emulsifiable water repellent agent for application on plywood and agglomerate wood boards characterized for including a system of self-emulsifiable nanometric colloidal dispersion, with 100% of linear saturated hydrocarbon based solids.

2. The emulsifiable water repellent agent for application on plywood and agglomerate wood boards according to claim 1, characterized for showing carbon chains defined by its composition between C18 to C42.

3. The emulsifiable water repellent agent for application on plywood and agglomerate wood boards according to claim 2, characterized for concentrating the biggest percentage of carbon chains in range of C34-32.

4. The emulsifiable water repellent agent for application on plywood and agglomerate wood boards according to claim 3, characterized for being hydrocarbons of vegetable and mineral origin.

5. The emulsifiable water repellent agent for application on plywood and agglomerate wood boards according to claim 4, characterized for using surfactant agents based on amine derivatives.

6. The emulsifiable water repellent agent for application on plywood and agglomerate wood boards according to claim 5, characterized for showing total compatibility with the formaldehyde resins, specifically urea formaldehyde.

7. The emulsifiable water repellent agent for application on plywood and agglomerate wood boards according to claim 6, characterized for showing control of emission of free formaldehyde in the formation of emulsion with the self-emulsifiable repellent agent.

8. The emulsifiable water repellent agent for application on plywood and agglomerate wood boards according to claim 7, characterized by a system of nanometric colloidal dispersion consisting of 100% solid repellent agent and urea formaldehyde resin.

9. The emulsifiable water repellent agent for application on plywood and agglomerate wood boards according to claim 3, characterized for presenting the following reactions:

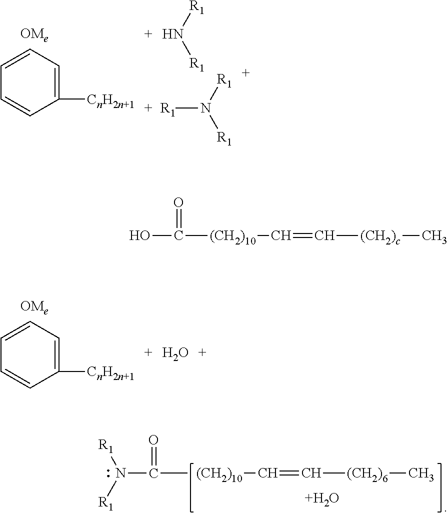

10. The emulsifiable water repellent agent for application on plywood and agglomerate wood boards according to claim 9, characterized for presenting repellence according to the principles of repellence action of the saturated chains in relation to water.

11. The emulsifiable water repellent agent for application on plywood and agglomerate wood boards according to claim 10, characterized by the bonding and adherence action of the plywood and agglomerate wood boards for following the adherence principles according to the bonding characteristics conceived by the urea formaldehyde resin, in accordance with the trials on the boards which show total compatibility without affecting the adherence.

12. An emulsifiable water repellent agent for application on plywood and agglomerate wood boards, characterized for:
(i) including a system of self-emulsifiable nanometric colloidal dispersion, with 100% of linear saturated hydrocarbon based solids;
(ii) showing carbon chains defined by its composition between C18 to C42 and concentrating the biggest percentage of carbon chains in range of C34-32; and
(iii) presenting the following reactions:

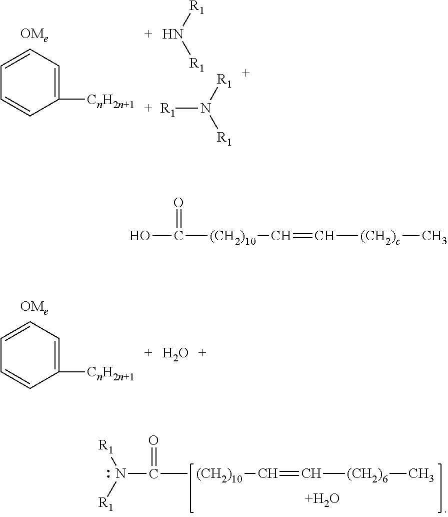

13. The emulsifiable water repellent agent for application on plywood and agglomerate wood boards according to claim 12, characterized for presenting repellence according to the principles of repellence action of the saturated chains in relation to water.

14. The emulsifiable water repellent agent for application on plywood and agglomerate wood boards according to claim 13, further characterized by the bonding and adherence action of the plywood and agglomerate wood boards for following the adherence principles according to the bonding characteristics conceived by the urea formaldehyde resin, in accordance with the trials on the boards which show total compatibility without affecting the adherence.

15. An emulsifiable water repellent agent for application on plywood and agglomerate wood boards, characterized for:
(i) including a system of self-emulsifiable nanometric colloidal dispersion, with 100% of linear saturated hydrocarbon based solids;
(ii) showing carbon chains defined by its composition between C18 to C42 and concentrating the biggest percentage of carbon chains in range of C34-32.
(iii) presenting the following reactions: 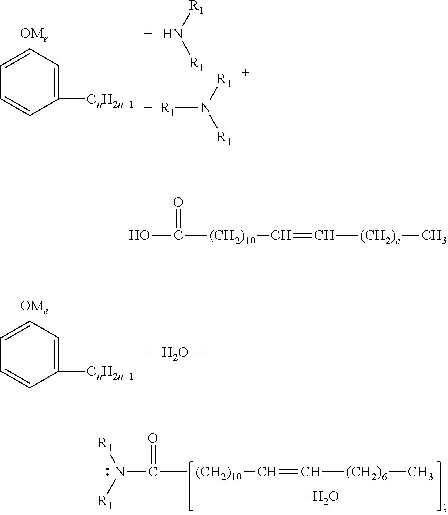
and
(iv) presenting repellence according to the principles of repellence action of the saturated chains in relation to water.

16. The emulsifiable water repellent agent for application on plywood and agglomerate wood boards according to claim 15, further characterized by the bonding and adherence action of the plywood and agglomerate wood boards for following the adherence principles according to the bonding characteristics conceived by the urea formaldehyde resin, in accordance with the trials on the boards which show total compatibility without affecting the adherence.
